(19) United States
(12) Patent Application Publication
(10) Pub. No.: US 2025/0119355 A1
(43) Pub. Date: Apr. 10, 2025

(54) DEVICE ESTIMATION SYSTEM, DEVICE ESTIMATION APPARATUS, PACKET ANALYSIS MODEL TRAINING APPARATUS, WAVEFORM ANALYSIS MODEL TRAINING APPARATUS, AND PROGRAM

(71) Applicant: Nippon Telegraph and Telephone Corporation, Tokyo (JP)

(72) Inventors: Chikako TAKASAKI, Musashino-shi, Tokyo (JP); Tomohiro KORIKAWA, Musashino-shi, Tokyo (JP); Masafumi SHIMIZU, Musashino-shi, Tokyo (JP); Naoki TAKAYA, Musashino-shi, Tokyo (JP)

(21) Appl. No.: 18/291,360

(22) PCT Filed: Aug. 4, 2021
(86) PCT No.: PCT/JP2021/028934

§ 371 Date: Jan. 23, 2024

(51) Int. Cl. H04L 41/14; H04L 41/16

(52) U.S. Cl. CPC H04L 41/145; H04L 41/16

(57) ABSTRACT

A device estimation system (1) includes a packet analysis model learning apparatus (20) for generating a packet analysis model (200), a waveform analysis model learning apparatus (30) for generating a waveform analysis model (300), a traffic information collection apparatus (50) for collecting packets of a target device (5), and a device estimation apparatus (10) for extracting a statistical value and a keyword from a packet, generating candidates for a manufacturer and a functional category of the target device (5) using the packet analysis model (200), generating traffic waveform information from the packet, narrowing down the candidates using the waveform analysis model (300), specifying the manufacturer and functional category of the target device (5), and transmitting the same to the analysis model management apparatus (40).

### TECHNICAL FIELD

The present invention relates to a device estimation system for estimating a device connected on a network, a device estimation apparatus, a packet analysis model learning apparatus, a waveform analysis model learning apparatus, and a program.

### BACKGROUND ART

A technique for detecting a suspicious device among devices installed in, for example, households has been developed in the related art (refer to NPL 1). In the technique described in the NPL 1, traffic transmitted by each Internet-of-Things (IoT) device is analyzed to extract feature values unique to the device. Then, machine learning is performed by using the feature values, thereby classifying the model of the device and the functional category of the device (for example, a web camera or a smart speaker).

### CITATION LIST

### Non Patent Literature

[NPL 1] A. Savanathan et al., “Characterizing and classifying IoT traffic in smart cities and campuses,” 2017 IEEE Conference on Computer Communications Workshops (INFOCOM WKSHPS), 2017, pp. 559-564, doi: 10.1109/INFCOMW.2017.8116438

### SUMMARY OF INVENTION

### Technical Problem

According to the technique described in the above-described NPL 1, traffic information is converted into numerical feature values such as packet transmission intervals for each protocol, and an IoT device is identified by using machine learning. At that time, a plurality of IoT devices is set in advance for an IoT device to be identified, and a specific IoT device is identified from among the devices.

However, in general households and companies (factories) actually connected to a network, very high costs are incurred in managing a very large number of diverse devices such as IoT terminals as a system, and a technique for efficiently managing the devices has not been established. As introduced in the technique of NPL 1, each device has characteristic traffic, and although it is possible to identify each device with high accuracy, there is a problem that identification is less relevant to its manufacturer or functional category, and the accuracy in such classification is lower.

In view of this, the present invention has been made to improve the accuracy at which the manufacturer and functional category of a target device are estimated from traffic of each device.

### Solution to Problem

A device estimation system according to the present invention is a device estimation system having a device on a network to be estimated, the device estimation system including a traffic information collection apparatus that collects traffic information of a target device indicating the device to be estimated; a device estimation apparatus connected to the traffic information collection apparatus; and a packet analysis model learning apparatus, a waveform analysis model learning apparatus, and an analysis model management apparatus connected to the device estimation apparatus, in which the packet analysis model learning apparatus acquires and learns a first learning data set from the analysis model management apparatus to generate a packet analysis model for outputting a candidate for a manufacturer and a functional category of the target device when a statistical value and a keyword extracted from a header and a payload of a packet transmitted by the target device are input, and the waveform analysis model learning apparatus acquires and learns a second learning data set from the analysis model management apparatus to generate a waveform analysis model for outputting the functional category of the target device when traffic waveform information indicating a temporal change in the number of packets transmitted by the target device is input, the traffic information collection apparatus including a data collection section that collects packets in traffic on the network; and a packet set generation section that generates packet set information in which the collected packets are grouped into a set for each transmission source device that is the target device, and the device estimation apparatus including a device connection information extraction unit that receives the packet set information and extracts device connection information indicating information for connecting to the target device; a packet processing unit that receives the packet set information from the traffic information collection apparatus, extracts the statistical value and keyword from the header and payload of the packet of the target device, inputs the statistical value and keyword to the packet analysis model acquired from the packet analysis model learning apparatus, and thereby generates device classification candidate information indicating a candidate for the manufacturer and functional category of the target device; a traffic waveform processing unit that receives the packet set information from the traffic information collection apparatus, generates the traffic waveform information of the target device, inputs the traffic waveform information to the waveform analysis model acquired from the waveform analysis model learning apparatus, then determines the functional category of the target device, and estimates that, among candidates for the manufacturer and functional category indicated by the device classification candidate information, a candidate having the determined functional category is for the manufacturer and functional category of the target device; and a device specifying unit that generates device specification information including the estimated manufacturer and functional category and the extracted device connection information of the target device and transmits the device specification information to the analysis model management apparatus.

### Advantageous Effects of Invention

According to the present invention, it is possible to improve the accuracy of estimating the manufacturer or functional category of a target device from traffic for each device.

### BRIEF DESCRIPTION OF DRAWINGS

FIG. 1 is a diagram illustrating an overall configuration of a device estimation system including a device estimation apparatus, and the like according to the present embodiment.

FIG. 2 is a diagram illustrating a data configuration example of device classification candidate information according to the present embodiment.

FIG. 3 is a diagram showing an example of traffic waveform information according to the present embodiment.

FIG. 4 is a diagram showing an example of traffic waveform information according to the present embodiment.

FIG. 5 is a functional block diagram of a packet analysis model learning apparatus according to the present embodiment.

FIG. 6 is a functional block diagram of a waveform analysis model learning apparatus according to the present embodiment.

FIG. 7 is a functional block diagram of an analysis model management apparatus according to the present embodiment.

FIG. 8 is a flowchart showing the flow of processing of the device estimation system according to the present embodiment.

FIG. 9 is a hardware configuration diagram illustrating an example of a computer that realizes functions of each apparatus of the device estimation system according to the present embodiment.

### DESCRIPTION OF EMBODIMENTS

Next, an embodiment for carrying out the present invention (hereinafter, referred to as “the present embodiment”) will be described.

A device estimation system 1 including a device estimation apparatus 10 and the like according to the present embodiment performs analysis in two steps, namely a step of analyzing header and payload information of a packet (packet analysis step) and a step of analyzing a traffic waveform representing a temporal change in traffic (traffic waveform analysis step) by using traffic information transmitted by a device to further improve the accuracy compared with in the related art when estimating the manufacturer and functional category of a target device.

The device estimation system 1 including the device estimation apparatus 10 and the like of the present invention will be described in detail below.

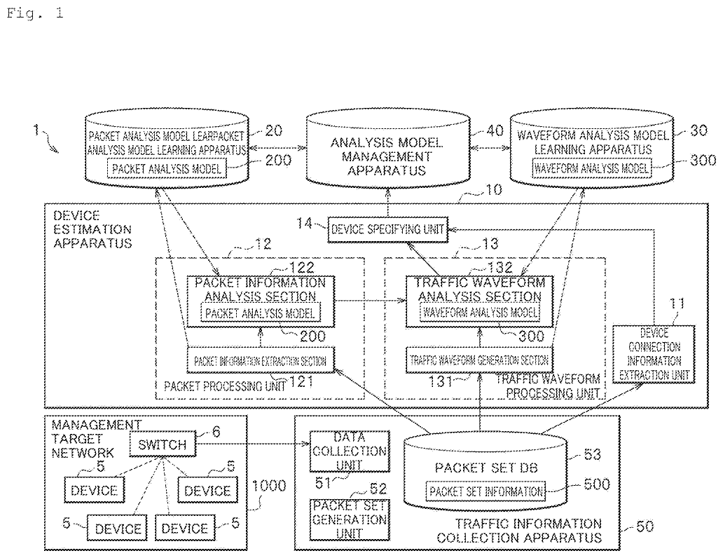

FIG. 1 is a diagram illustrating an overall configuration of the device estimation system 1 including the device estimation apparatus 10, and the like according to the present embodiment.

The device estimation system 1 estimates the manufacturer and functional category of a device 5 to be estimated (hereinafter referred to as a “target device 5”) among a plurality of devices 5 accommodated on a management target network 1000.

As illustrated in FIG. 1, the device estimation system 1 includes a device estimation apparatus 10, a packet analysis model learning apparatus 20, a waveform analysis model learning apparatus 30, an analysis model management apparatus 40, and a traffic information collection apparatus 50.

The device estimation system 1 is communicatively connected to the management target network 1000 via the traffic information collection apparatus 50, and sets each device 5 accommodated on the management target network 1000 as an estimation target. Hereinafter, the traffic information collection apparatus 50, the device estimation apparatus 10, the packet analysis model learning apparatus 20, the waveform analysis model learning apparatus 30, and the analysis model management apparatus 40 constituting the device estimation system 1 will be described in detail.

### <Traffic Information Collection Apparatus>

The traffic information collection apparatus 50 captures (collects) packets of traffic flowing on the management target network 1000 and performs processing for storing the packets in each transmission source device.

The traffic information collection apparatus 50 is configured by a computer that includes a control unit, an input/output unit, and a storage unit (none of which is illustrated).

The input/output unit performs input/output of information between a switch 6 accommodated in the management target network 1000 and the device estimation apparatus 10 or the like. This input/output unit includes a communication interface for transmitting and receiving information via a communication line, and an input/output interface for performing input/output of information between an input device such as a keyboard and an output device such as a monitor, none of which is illustrated.

The storage unit includes a hard disk, a flash memory, a random access memory (RAM), and the like.

The storage unit stores a packet set database (DB) 53 for storing packet set information 500 (of which details will be described later) obtained by analyzing traffic information collected from the management target network 1000 by a data collection unit 51, which will be described below.

Further, the storage unit temporarily stores a program for implementing functions of the control unit and information necessary for processing performed by the control unit.

The control unit controls overall processing operations executed by the traffic information collection apparatus 50 and includes the data collection unit 51 and a packet set generation unit 52.

The data collection unit 51 captures (collects) packets of traffic flowing on the management target network 1000 via the switch 6 accommodated on the management target network 1000.

The packet set generation unit 52 groups the packets collected by the data collection unit 51 for each transmission source device (for example, a MAC address of a target device 5), and generates the packet set information 500 for each target device 5. Then, the packet set generation unit 52 stores the generated packet set information 500 in the packet set DB 53. The packet set generation unit 52 also transmits the packet set information 500 of each target device 5 to the device estimation apparatus 10.

In this manner, the traffic information collection apparatus 50 can generate the packet set information 500 in which each device 5 accommodated on the management target network 1000 is a transmission source, and output the packet set information 500 to the device estimation apparatus 10.

Further, although the traffic information collection apparatus 50 is described as one unit in this embodiment, a plurality of traffic information collection apparatuses 50 may be provided according to a plurality of management target networks 1000. Furthermore, a plurality of traffic information collection apparatuses 50 may be provided for one management target network 1000, thereby increasing the speed of packet collection and generation of the packet set information 500. Furthermore, the packet set DB 53 storing the packet set information 500 may be provided in a device in a separate housing from the traffic information collection apparatus 50.

### <Device Estimation Apparatus>

Next, the device estimation apparatus 10 will be described with reference to FIG. 1.

The device estimation apparatus 10 acquires the packet set information 500 of a target device 5 from the traffic information collection apparatus 50, analyzes information of the header and payload of a packet by using a packet analysis model 200 (of which details will be described later), and generates device classification candidates (“device classification candidate information 210” to be described later) indicating the manufacturer and functional category of the target device 5. In addition, the device estimation apparatus 10 generates a traffic waveform representing a temporal change in traffic from the packet set information 500, estimates the functional category of the target device 5 by analyzing the traffic waveform using a waveform analysis model 300 (of which details will be described later), and specifies the manufacturer and functional category of the target device 5 among the device classification candidates. The device estimation apparatus 10 is configured by a computer that includes a control unit, an input/output unit, and a storage unit (none of which is illustrated).

The input/output unit of the device estimation apparatus 10 performs input/output of information among the traffic information collection apparatus 50, the packet analysis model learning apparatus 20, the waveform analysis model learning apparatus 30, the analysis model management apparatus 40, and the like. This input/output unit includes a communication interface for transmitting and receiving information via a communication line, and an input/output interface for performing input/output of information between an input device such as a keyboard and an output device such as a monitor, none of which is illustrated.

The storage unit of the device estimation apparatus 10 includes a hard disk, a flash memory, a RAM, or the like. The storage unit stores the packet analysis model 200 acquired from the packet analysis model learning apparatus 20 and used for processing of a packet information analysis section 122, which will be described below, and the waveform analysis model 300 acquired from the waveform analysis model learning apparatus 30 and used for processing of a traffic waveform analysis section 132, which will be described below. Further, the storage unit temporarily stores a program for implementing functions of the control unit and information necessary for processing performed by the control unit.

The control unit of the device estimation apparatus 10 controls the overall processing operations executed by the device estimation apparatus 10, and includes a device connection information extraction unit 11, a packet processing unit 12, a traffic waveform processing unit 13, and a device specifying unit 14.

The device connection information extraction unit 11 receives the packet set information 500 of the target device 5 from the traffic information collection apparatus 50 via the input/output unit (not shown), and extracts, from the header or the like of a packet, information necessary for connection to the target device 5 (for example, a MAC address, an IP address, etc.) as device connection information.

The device connection information extraction unit 11 outputs the extracted device connection information to the device specifying unit 14 for each target device 5.

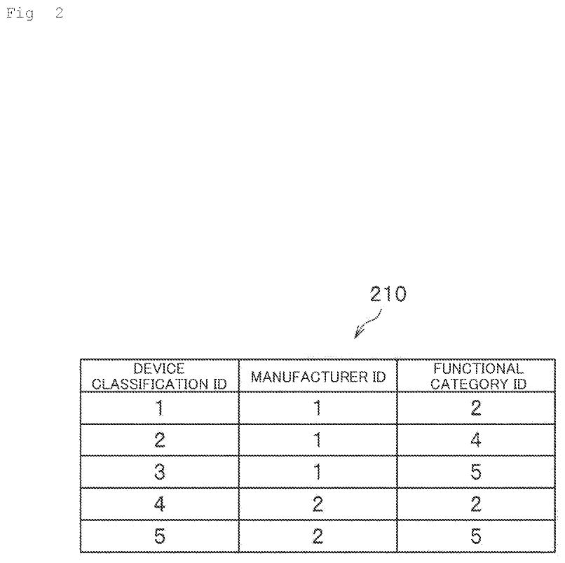

The packet processing unit 12 acquires the packet analysis model 200 generated by the packet analysis model learning apparatus 20 in advance. Then, the packet processing unit 12 receives the packet set information 500 of the target device 5 from the traffic information collection apparatus 50, and extracts a statistical value and a keyword from the header and payload of the packet as header/payload information. The packet processing unit 12 inputs the header/payload information to the packet analysis model 200 to generate device classification candidate information 210 (see FIG. 2, which will be described later) indicating candidates for the manufacturer and functional category of the target device 5. The packet processing unit 12 includes a packet information extraction section 121 and a packet information analysis section 122.

The packet information extraction section 121 receives the packet set information 500 of the target device 5 from the traffic information collection apparatus 50 through the input/output unit (not illustrated). Then, the packet information extraction section 121 extracts a statistical value and a keyword from the header and the payload of the packet as header/payload information. Here, the statistical value is information indicating a feature of each packet in traffic flowing through the network, including, for example, a packet rate (pps), a packet size, the number of packets transmitted, a destination address, the number of transmission destinations, and the like. The keyword includes, for example, a character string pattern, a host name, or a server name of domain name system (DNS) if it is a DNS packet.

The packet information extraction section 121 outputs the extracted header/payload information to the packet information analysis section 122. In addition, the packet information extraction section 121 transmits the extracted header/payload information to the packet analysis model learning apparatus 20. The transmitted information is used by the packet analysis model learning apparatus 20 to update the packet analysis model 200.

The packet information analysis section 122 acquires the packet analysis model 200 generated by the packet analysis model learning apparatus 20 in advance. Furthermore, the packet information analysis section 122 acquires, from the packet analysis model learning apparatus 20, the latest packet analysis model 200, for example, at predetermined time intervals or just before each processing operation, and updates the packet analysis model 200 to be used by itself.

When the packet information analysis section 122 acquires the header/payload information from the packet information extraction section 121, the packet information analysis section 122 inputs the acquired header/payload information to the packet analysis model 200 to generate device classification candidate information 210 (see FIG. 2) indicating candidates for the manufacturer and functional category of the target device 5.

The device classification candidate information 210 is information obtained by extracting classification of candidate devices for narrowing down the manufacturer and functional category of the target device 5, and stores, for example, manufacturer IDs and functional category Ids in association with device classification IDs to indicate a plurality of candidates as shown in FIG. 2. Here, the device classification IDs are each identification information of classification indicated by a combination of a manufacturer and a functional category. Each manufacturer ID is identification information of the manufacturer (seller) of the device 5. Each functional category ID is identification information of a functional category. As the functional categories, for example, television, digital camera, sensor device (temperature sensor, humidity sensor, acceleration sensor, or the like), lighting device, smart speaker, smart switch, smart hub, automobile, industrial robot, and the like are set.

The device classification candidate information 210 shown in FIG. 2 is obtained by arranging, in from the first line to the fifth line device classification candidates having a probability closer to being a correct answer of the combination of the manufacturer and functional category of the target device 5 as the analysis result of the packet analysis model 200 in order of candidates having higher probabilities of being the correct answer.

FIG. 2 shows an example in which the device classification candidates are output in order of the candidates having higher correct answer probabilities, including a case in which the manufacturer IDs are “1” and “2” and the manufacturers are different. In an example other than this, it is also possible to select one manufacturer having a high probability of being the correct answer and then output the functional category of the manufacturer as the device classification candidate in order of candidates having higher probabilities of being the correct answer.

The packet information analysis section 122 outputs the generated device classification candidate information 210 to the traffic waveform processing unit 13 (hereinafter referred to as a “traffic waveform analysis section 132”).

Referring back to FIG. 1, the traffic waveform processing unit 13 acquires the waveform analysis model 300 previously generated by the waveform analysis model learning apparatus 30. Then, the traffic waveform processing unit 13 receives the packet set information 500 of the target device 5 from the traffic information collection apparatus 50, generates a traffic waveform representing a temporal change in traffic, and estimates (determines) the functional category of the target device 5 by analyzing the traffic waveform using the waveform analysis model 300. Then, the traffic waveform processing unit 13 narrows down the target devices 5 in the determined functional category among the device candidates indicated by the device classification candidate information 210 generated by the packet processing unit 12, and thereby estimates the manufacturer and functional category of the target device 5.

The traffic waveform processing unit 13 includes a traffic waveform generation section 131 and a traffic waveform analysis section 132.

The traffic waveform generation section 131 receives the packet set information 500 of the target device 5 from the traffic information collection apparatus 50 via the input/output unit (not illustrated), and calculates the number of packets transmitted per unit time of the target device 5 to generate a waveform (traffic waveform information) indicating a temporal change in the packets transmitted.

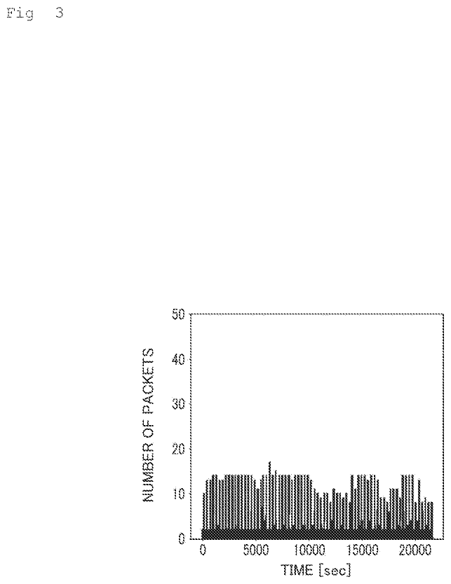

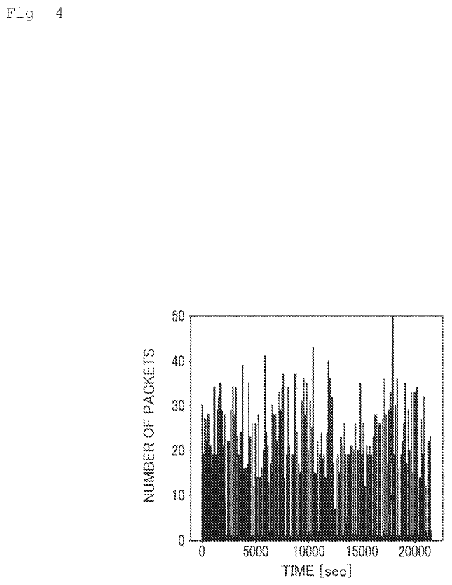

FIG. 3 and FIG. 4 show examples of traffic waveform information, wherein FIG. 3 shows a smart hub and FIG. 4 shows the traffic waveform of a smart switch. In this way, the waveforms of traffic varying depending on functional categories are learned as the waveform analysis model 300. Thus, the traffic waveform information is input to the waveform analysis model 300, and the functional category is estimated from the waveform.

The traffic waveform generation section 131 outputs the generated traffic waveform information to the traffic waveform analysis section 132. The traffic waveform generation section 131 transmits the generated traffic waveform information to the waveform analysis model learning apparatus 30. This transmitted information is used by the waveform analysis model learning apparatus 30 to update the waveform analysis model 300.

The traffic waveform analysis section 132 acquires the waveform analysis model 300 generated by the waveform analysis model learning apparatus 30 in advance. Furthermore, the traffic waveform analysis section 132 acquires, from the waveform analysis model learning apparatus 30, the latest waveform analysis model 300, for example, at predetermined time intervals or just before each processing operation, and updates the waveform analysis model 300 to be used by itself.

Upon acquiring the traffic waveform information of the target device 5 from the traffic waveform generation section 131, the traffic waveform analysis section 132 inputs the acquired traffic waveform information to the waveform analysis model 300 to estimate (determine) the functional category of the target device 5.

Then, the traffic waveform analysis section 132 refers to the device classification candidate information 210 (see FIG. 2) acquired from the packet processing unit 12 (packet information analysis section 122), narrows down the device classification candidates belonging to the determined functional category, and estimates the manufacturer and functional category of the target device 5.

In this case, if the analysis result by the waveform analysis model 300 is the functional category of the functional category ID “4,” for example, the traffic waveform analysis section 132 estimates that the device with the device classification ID “2” (the manufacturer ID “1,” and the functional category ID “4”) among the device candidates shown in FIG. 2 is the classification of the target device 5.

In addition, if the analysis result by the waveform analysis model 300 is the functional category ID “2,” for example, the traffic waveform analysis section 132 estimates that the device with the device classification ID “1” (the device classification candidate in the first row) determined to have a probability of being close to the correct answer in the packet analysis model 200 (the manufacturer ID “1” and the functional category ID “2”) among two device classification candidates with the functional category ID “2” shown in FIG. 2 is the classification of the target device 5.

Furthermore, if the same functional category as the functional category (e.g., it is assumed to be the functional category ID “6”) indicated by the analysis result by the waveform analysis model 300 is the device classification candidate information 210 (FIG. 2), the traffic waveform analysis section 132 estimates that the device with the device classification ID “1” (the device classification candidate in the first row) determined to have a probability of being close to the correct answer in the packet analysis model 200 (the manufacturer ID “1” and the functional category ID “2”) among the device classification candidates is the classification of the target device 5.

The traffic waveform analysis section 132 outputs the information of the estimated manufacturer and functional category of the target device 5 (hereinafter referred to as “estimation result information”) to the device specifying unit 14.

The device specifying unit 14 receives the estimation result information from the traffic waveform analysis section 132, and receives device connection information from the device connection information extraction unit 11 to specify the manufacturer, functional category, and device connection information for the target device 5, and generate device specification information.

Then, the device specifying unit 14 transmits the device specification information including the manufacturer, functional category, and device connection information of the target device 5 to the analysis model management apparatus 40.

In this way, the device estimation apparatus 10 generates the device classification candidate information 210 by inputting header/payload information extracted from the packet set information 500 of the target device 5 to the packet analysis model 200, narrows down the device classification candidates to the functional category obtained by analyzing the traffic waveform information of the target device 5 by using the waveform analysis model 300, and thus can specify the manufacturer and the functional category of the target device 5.

Although the device estimation system 1 includes one device estimation apparatus 10 in the present embodiment, when there is a plurality of management target networks 1000, a plurality of device estimation apparatuses 10 each corresponding to management target networks 1000 may be provided. In this case, the plurality of device estimation apparatuses 10 are connected to the packet analysis model learning apparatus 20, the waveform analysis model learning apparatus 30, and the analysis model management apparatus 40, respectively.

### <Packet Analysis Model Learning Apparatus>

Next, the packet analysis model learning apparatus 20 according to the present embodiment will be described.

The packet analysis model learning apparatus 20 is an apparatus for generating the packet analysis model 200 for inputting header/payload information, which is information of statistical values and keywords that can be extracted from the header and payload of a packet transmitted from the target device 5, and outputting the device classification candidate information 210 (see FIG. 2) indicating candidates for the manufacturer and functional category of the target device 5. The packet analysis model learning apparatus 20 generates the packet analysis model 200 by learning a set of header/payload information and the manufacturer and functional category of the target device as a data set for learning.

A learning method used by the packet analysis model learning apparatus 20 includes, for example, a machine learning method of multiple regression analysis, random forest, or a neural network or a method of pattern matching or the like. In the following description, it is assumed that machine learning is performed.

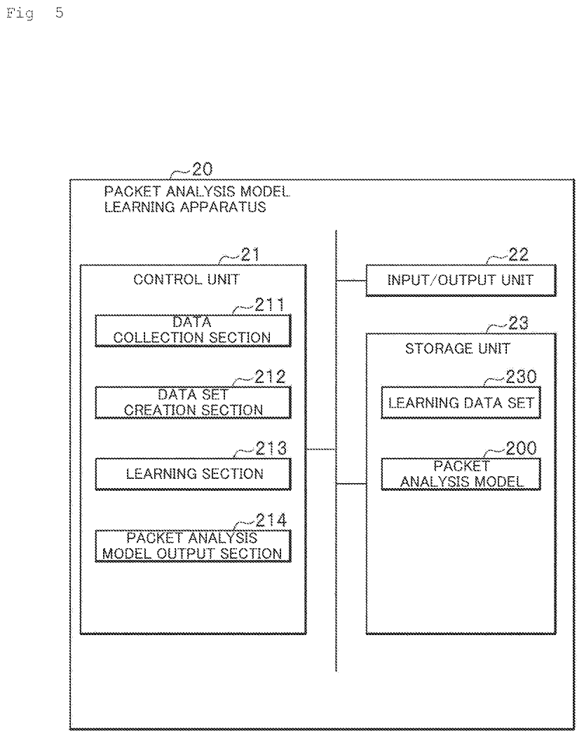

The packet analysis model learning apparatus 20 includes a control unit 21, an input/output unit 22, and a storage unit 23 as illustrated in FIG. 5.

The input/output unit 22 performs input/output of information with the analysis model management apparatus 40, the device estimation apparatus 10, or the like. The input/output unit 22 includes a communication interface through which information is transmitted and received via a communication line, and an input/output interface through which information is input to and output from an input device such as a keyboard and an output device such as a monitor, none of which are not illustrated.

The storage unit 23 includes a hard disk, a flash memory, a RAM, or the like.

In the storage unit 23, a set of header/payload information which is information of a statistical value and a keyword which can be extracted from the header and payload of a packet transmitted from the target device 5, and the manufacturer and functional category of the target device 5 is stored as a learning data set 230. In addition, the packet analysis model 200 generated from machine learning using the learning data set 230 is stored in the storage unit 23.

Further, the storage unit 23 temporarily stores a program for implementing functional units of the control unit 21 and information that is necessary for processing performed by the control unit 21.

The control unit 21 controls the overall processing executed by the packet analysis model learning apparatus 20, and includes a data collection section 211, a data set creation section 212, a learning section 213, and a packet analysis model output section 214.

The data collection section 211 acquires, in an initial model construction stage (which will be referred to as an “initial stage” below) that is prior to a stage in which the device estimation apparatus 10 performs a device estimation process (which will be referred to as an “operation stage” below), data (a “first learning data set 431” to be described later) composed of a set of header/payload information and the manufacturer and functional category of a device 5 which are correct answer data corresponding to the header/payload information from the analysis model management apparatus 40, and stores the data in the storage unit 23 as the learning data set 230 to be held by itself.

In addition, the data collection section 211 acquires the header/payload information extracted for the target device 5 from the packet information extraction section 121 of the device estimation apparatus 10 in the operation stage.

The data set creation section 212 acquires information (correct answer information) of the manufacturer and functional category indicated by the device specification information acquired as a processing result by the device estimation apparatus 10 of the target device 5 from the analysis model management apparatus 40 about the header/payload information of the target device 5 acquired from the device estimation apparatus 10 by a data collection section 211 in the operation stage. Then, the data set creation section 212 newly creates a learning data set 230 composed of a set of the header/payload information and the manufacturer and the functional category, and stores the set in the storage unit 23.

The data set creation section 212 transmits the created learning data set 230 to the analysis model management apparatus 40.

The learning section 213 generates the packet analysis model 200 by performing machine learning using the learning data set 230 (first learning data set 431) acquired from the analysis model management apparatus 40 by the data collection section 211 in the initial stage.

In addition, in the operation stage, the learning section 213 further performs machine learning using the learning data set 230 created by the data set creation section 212 with the set of the header/payload information of the target device 5 acquired from the device estimation apparatus 10 (packet information extraction section 121) and the information (correct answer information) of the manufacturer and functional category indicated by the device specification information of the target device 5 acquired from the analysis model management apparatus 40, and updates the packet analysis model 200.

The packet analysis model output section 214 outputs the packet analysis model 200 generated by the learning section 213 to the device estimation apparatus 10 (packet information analysis section 122) in the initial stage. In addition, the packet analysis model output section 214 outputs the packet analysis model 200 updated by the learning section 213 to the device estimation apparatus 10 (packet information analysis section 122) in the operation stage.

Thus, the packet analysis model learning apparatus 20 can improve the estimation performance by re-learning (updating) the packet analysis model 200 by using the new learning data set 230 in the operation stage.

### <Waveform Analysis Model Learning Apparatus>

Next, the waveform analysis model learning apparatus 30 according to the present embodiment will be described.

The waveform analysis model learning apparatus 30 is a device for inputting a waveform (traffic waveform information) indicating a temporal change in the number of packets transmitted and generating the waveform analysis model 300 for outputting the functional category of the target device 5.

A learning method used by the waveform analysis model learning apparatus 30 includes, for example, a machine learning method of multiple regression analysis, random forest, or a neural network or a method of pattern matching or the like. In the following description, it is assumed that machine learning is performed.

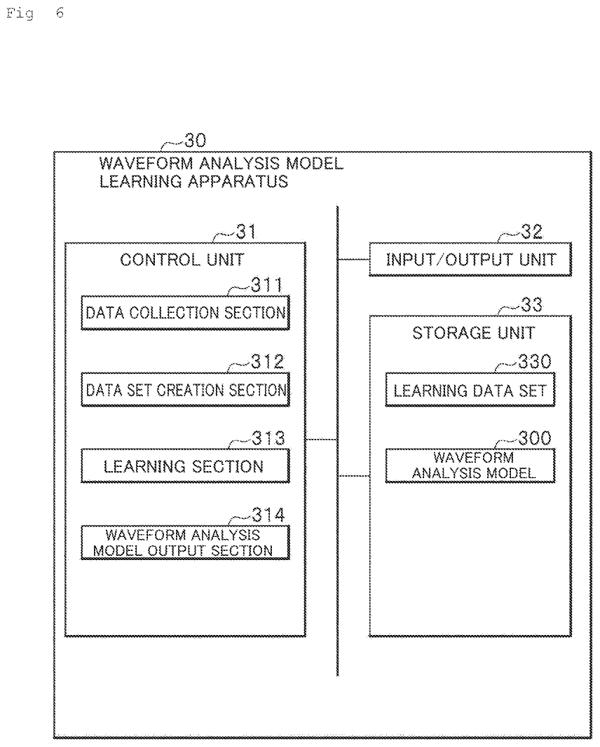

The waveform analysis model learning apparatus 30 includes a control unit 31, an input/output unit 32, and a storage unit 33 as illustrated in FIG. 6.

The input/output unit 32 performs input/output of information with the analysis model management apparatus 40, the device estimation apparatus 10, or the like. The input/output unit 32 is composed of a communication interface through which information is transmitted and received via a communication line, and an input/output interface through which information is input to and output from an input device such as a keyboard and an output device such as a monitor, none of which is not illustrated.

The storage unit 33 includes a hard disk, a flash memory, a RAM, or the like.

In the storage unit 33, a set of the waveform (traffic waveform information) indicating a temporal change in the number of packets transmitted by the target device 5 and the functional category of the target device 5 is stored as a learning data set 330. In addition, the waveform analysis model 300 generated from machine learning using the learning data set 330 is stored in the storage unit 33.

Further, the storage unit 33 temporarily stores a program for causing functional units of the control unit 31 to be implemented and information necessary for processing performed by the control unit 31.

The control unit 31 controls the overall processing executed by the waveform analysis model learning apparatus 30, and includes a data collection section 311, a data set creation section 312, a learning section 313, and a waveform analysis model output section 314.

The data collection section 311 acquires, in an initial model construction stage (an initial stage) that is prior to a stage in which the device estimation apparatus 10 performs a device estimation process (an operation stage), data (a “second learning data set 432” to be described later) composed of a set of the traffic waveform information and the functional category of the target device 5 from the analysis model management apparatus 40 and stores the data in the storage unit 33 as the learning data set 330 to be held by itself.

In addition, the data collection section 311 acquires the traffic waveform information generated for the target device 5 from the traffic waveform generation section 131 of the device estimation apparatus 10 in the operation stage.

The data set creation section 312 acquires information (correct answer information) of the functional category indicated by the device specification information acquired as a processing result of the target device 5 by the device estimation apparatus 10 from the analysis model management apparatus 40 with respect to the traffic waveform information of the target device 4 acquired from the device estimation apparatus 10 by the data collection section 311 in the operation stage. Then, the data set creation section 312 creates a new learning data set 330 composed of a set of traffic waveform information and a functional category and stores the data in the storage unit 33.

The data set creation section 312 transmits the created learning data set 330 to the analysis model management apparatus 40.

The learning section 313 generates the waveform analysis model 300 by performing machine learning using the learning data set 330 (second learning data set 432) acquired by the data collection section 311 from the analysis model management apparatus 40 in the initial stage.

In addition, in the operation stage, the learning section 313 further performs machine learning using the learning data set 330 created by the data set creation section 312 with the set of the traffic waveform information of the target device 5 acquired from the device estimation apparatus 10 (traffic waveform generation section 131) and the functional category (correct answer information) indicated by the device specification information of the target device 5 acquired from the analysis model management apparatus 40, and updates the waveform analysis model 300.

The waveform analysis model output section 314 outputs the waveform analysis model 300 generated by the learning section 313 to the device estimation apparatus 10 (traffic waveform analysis section 132) in the initial stage. In addition, the waveform analysis model output section 314 outputs the waveform analysis model 300 updated by the learning section 313 to the device estimation apparatus 10 (traffic waveform analysis section 132) in the operation stage.

Thus, the waveform analysis model learning apparatus 30 can improve the estimation performance by re-learning (updating) the waveform analysis model 300 by using the new learning data set 330 in the operation stage.

### <Analysis Model Management Apparatus>

Next, the analysis model management apparatus 40 according to the present embodiment will be described.

The analysis model management apparatus 40 is an apparatus for managing learning data (learning data sets) to improve the estimation performance for the packet analysis model 200 generated by the packet analysis model learning apparatus 20 and the waveform analysis model 300 generated by the waveform analysis model learning apparatus 30.

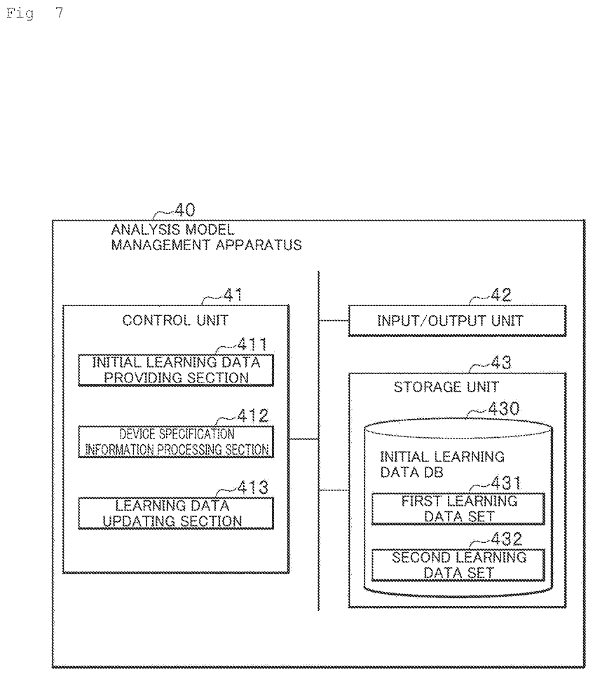

The analysis model management apparatus 40 includes a control unit 41, an input/output unit 42, and a storage unit 43 as illustrated in FIG. 7.

The input/output unit 42 performs input/output of information to/from the packet analysis model learning apparatus 20, the waveform analysis model learning apparatus 30, the device estimation apparatus 10, and the like. The input/output unit 42 is composed of a communication interface through which information is transmitted and received via a communication line, and an input/output interface through which information is input to and output from an input device such as a keyboard and an output device such as a monitor, none of which is not illustrated.

The storage unit 43 includes a hard disk, a flash memory, a RAM, or the like.

The storage unit 43 includes an initial learning data DB 430. The initial learning data DB 430 stores data (first learning data set 431) composed of a set of header/payload information and the manufacturer and functional category of the device 5 which are correct answer data corresponding to the header/payload information to be transmitted to the packet analysis model learning apparatus 20 in the initial stage. In addition, the initial learning data DB 430 stores data (second learning data set 432) composed of a set of traffic waveform information and the functional category of the target device 5 to be transmitted to the waveform analysis model learning apparatus 30 in the initial stage.

Furthermore, the storage unit 43 temporarily stores a program for causing each functional unit of the control unit 41 to be implemented and information necessary for processing performed by the control unit 41.

The control unit 41 controls the overall processing executed by the analysis model management apparatus 40, and includes an initial learning data providing section 411, a device specification information processing section 412, and a learning data updating section 413.

The initial learning data providing section 411 transmits the data (first learning data set 431) composed of a set of header/payload information and the manufacturer and functional category of the device 5 which are correct answer data corresponding to the header/payload information to the packet analysis model learning apparatus 20 as a learning data set in the initial stage. Thus, the packet analysis model learning apparatus 20 performs machine learning to generate the packet analysis model 200.

Furthermore, the initial learning data providing section 411 transmits the data (second learning data set 432) composed of the set of the traffic waveform information and the functional category of the target device 5 to the waveform analysis model learning apparatus 30 as a learning data set in the initial stage. Thus, the waveform analysis model learning apparatus 30 performs machine learning to generate the waveform analysis model 300.

The device specification information processing section 412 acquires, from the device estimation apparatus 10 (device specifying unit 14), the device specification information in which the manufacturer, the functional category, and the device connection information of the target device 5 are specified.

Then, the device specification information processing section 412 transmits the acquired device specification information to the packet analysis model learning apparatus 20 and the waveform analysis model learning apparatus 30.

The learning data updating section 413 acquires a newly created learning data set 230 from the packet analysis model learning apparatus 20 (data set creation section 212). Then, the learning data updating section 413 adds the acquired learning data set 230 to the first learning data set 431 stored in the initial learning data DB 430 and updates the data set.

In addition, the learning data updating section 413 acquires a newly created learning data set 330 from the waveform analysis model learning apparatus 30 (data set creation section 312). Then, the learning data updating section 413 adds the acquired learning data set 330 to the second learning data set 432 stored in the initial learning data DB 430 and updates the data set.

By doing as described above, the analysis model management apparatus 40 can be provided with the learning data set to which more accurate learning data has been added as the learning data set for the initial stage.

Thus, the packet analysis model learning apparatus 20 can create the learning data set with the set of the header/payload information of the target device 5 acquired in the operation stage and the information (correct answer information) of the manufacturer and functional category indicated by the device specification information of the target device 5 acquired from the analysis model management apparatus 40 and update the packet analysis model 200 by performing machine learning.

In addition, the waveform analysis model learning apparatus 30 can create the learning data set with the set of the traffic waveform information of the target device 5 acquired in the operation stage and the functional category (correct answer information) indicated by the device specification information of the target device 5 acquired from the analysis model management apparatus 40 and update the waveform analysis model 300 by performing machine learning.

### <Processing of Device Estimation System>

Next, the flow of the processing of the device estimation system 1 (device estimation process) according to the present embodiment will be described.

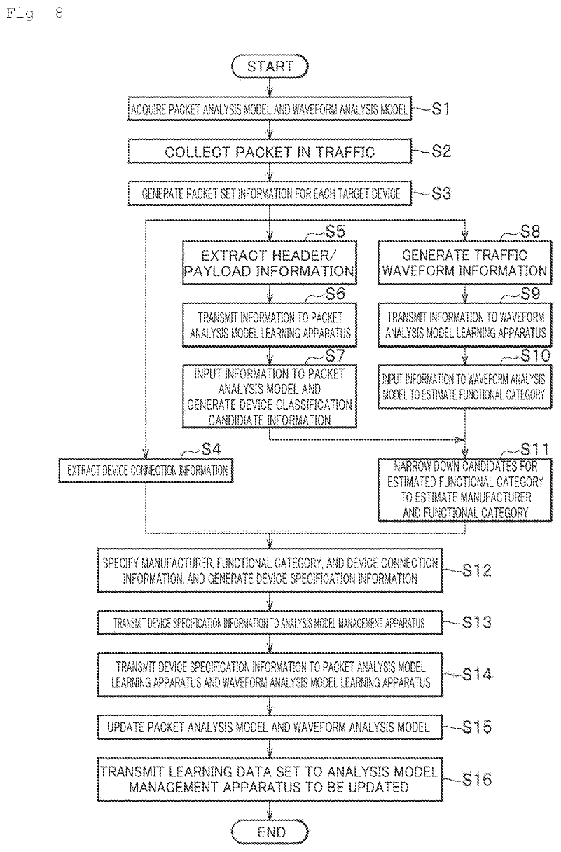

FIG. 8 is a flowchart showing the flow of processing of the device estimation system 1 according to the present embodiment.

Here, it is assumed that the packet analysis model learning apparatus 20 acquires a learning data set (first learning data set 431) from the analysis model management apparatus 40 in the initial stage and that the packet analysis model 200 has already been generated. Also, it is assumed that the waveform analysis model learning apparatus 30 acquires the learning data set (second learning data set 432) from the analysis model management apparatus 40 in the initial stage and that the waveform analysis model 300 has already been generated.

First, when a device estimation process is started, in the device estimation apparatus 10, the packet information analysis section 122 acquires the packet analysis model 200 from the packet analysis model learning apparatus 20. In addition, the traffic waveform analysis section 132 acquires the waveform analysis model 300 from the waveform analysis model learning apparatus 30 (step S1).

Next, the data collection unit 51 of the traffic information collection apparatus 50 captures (collects) packets of traffic flowing on the management target network 1000 via the switch 6 accommodated on the management target network 1000 (step S2).

Next, the packet set generation unit 52 of the traffic information collection apparatus 50 groups the collected packets for each transmission source device (for example, a MAC address of each target device 5), and generates the packet set information 500 for each target device 5 (step S3). Then, the packet set generation unit 52 stores the generated packet set information 500 in a packet set database 53 and transmits the information to the device estimation apparatus 10.

The device estimation apparatus 10 having received the packet set information 500 has the device connection information extraction unit 11, the packet processing unit 12, and the traffic waveform processing unit 13 executing the following processing.

This processing may be performed in parallel for each target device 5 by, for example, virtualizing each function of the device estimation apparatus 10 into a virtual machine (VM) or a container.

The device connection information extraction unit 11 of the device estimation apparatus 10 receives the packet set information 500 of the target device 5 from the traffic information collection apparatus 50, and extracts information (for example, a MAC address, an IP address, etc.) required for connection to the target device 5 from the header of a packet, etc. as device connection information (step S4).

Then, the device connection information extraction unit 11 outputs the extracted device connection information of the target device 5 to the device specifying unit 14.

The packet processing unit 12 (packet information extraction section 121) of the device estimation apparatus 10 receives the packet set information 500 of the target device 5 from the traffic information collection apparatus 50. Then, the packet information extraction section 121 extracts a statistical value and a keyword from the header and payload of the packet as header/payload information (step S5).

The packet information extraction section 121 outputs the extracted header/payload information to the packet information analysis section 122 and transmits the information to the packet analysis model learning apparatus 20 (step S6).

Next, the packet information analysis section 122 inputs the acquired header/payload information to the packet analysis model 200 to generate device classification candidate information 210 (refer to FIG. 2) indicating candidates for the manufacturer and functional category of the target device 5 (step S7).

Then, the packet information analysis section 122 outputs the generated device classification candidate information 210 to the traffic waveform processing unit 13.

The traffic waveform processing unit 13 (traffic waveform generation section 131) of the device estimation apparatus 10 receives the packet set information 500 of the target device 5 from the traffic information collection apparatus 50, calculates the number of packets transmitted per unit time of the target device 5, and thereby generates a waveform (traffic waveform information) indicating a temporal change in the packets transmitted (step S8).

The traffic waveform generation section 131 outputs the generated traffic waveform information to the traffic waveform analysis section 132 and transmits the information to the waveform analysis model learning apparatus 30 (step S9).

Then, the traffic waveform analysis section 132 inputs the acquired traffic waveform information to the waveform analysis model 300 to estimate (determine) the functional category of the target device 5 (step S10).

Then, the traffic waveform analysis section 132 refers to the device classification candidate information 210 (see FIG. 2) acquired from the packet processing unit 12 (packet information analysis section 122), narrows down the device classification candidates based on the determined functional category, and estimates the manufacturer and model category of the target device 5 (step S11).

Next, the traffic waveform analysis section 132 outputs the information of the estimated manufacturer and functional category of the target device 5 (estimation result information) to the device specifying unit 14.

The device specifying unit 14 receives the estimation result information from the traffic waveform analysis section 132, and receives the device connection information from the device connection information extraction unit 11 to specify the manufacturer, functional category, and device connection information for the target device 5, and generate device specification information (step S12).

Then, the device specifying unit 14 transmits the device specification information including the manufacturer, functional category, and device connection information of the target device 5 to the analysis model management apparatus 40 (step S13).

The device specification information processing section 412 of the analysis model management apparatus 40 transmits the acquired device specification information to the packet analysis model learning apparatus 20 and the waveform analysis model learning apparatus 30 (step S14).

Then, in a step S15, the packet analysis model learning apparatus 20 creates a new learning data set 230 based on the information (correct answer information) of the manufacturer and functional category indicated by the acquired device specification information and updates the packet analysis model 200. In addition, the waveform analysis model learning apparatus 30 creates a new learning data set 330 based on the functional category (correct answer information) indicated by the acquired device specification information, and updates the waveform analysis model 300.

The updated packet analysis model 200 and the updated waveform analysis model 300 are transmitted to the device estimation apparatus 10 at predetermined timing. As a result, the estimation performance of the device estimation apparatus 10 can be improved.

Furthermore, the packet analysis model learning apparatus 20 and the waveform analysis model learning apparatus 30 transmit the newly created learning data sets 230 and 330 to the analysis model management apparatus 40, and add a learning data set for the initial stage (first learning data set 431 and second learning data set 432) thereto to be updated (step S16).

Thereby, the processing (device estimation process) of the device estimation system 1 ends.

### <Hardware Configuration>

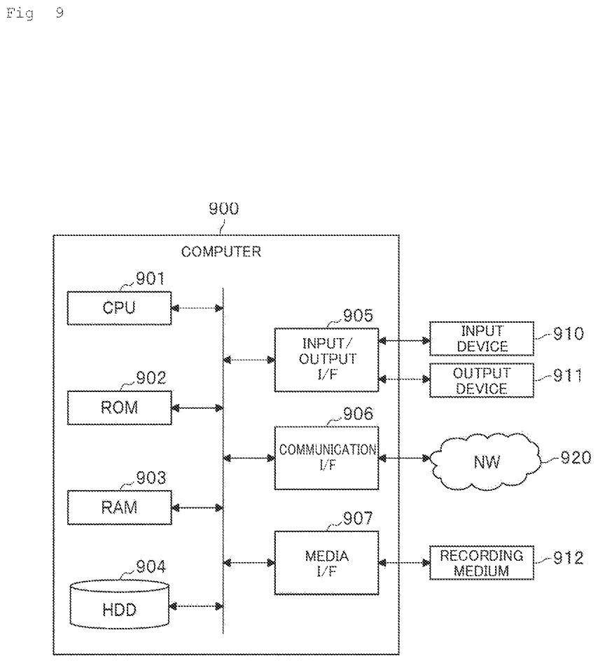

The respective apparatuses (the device estimation apparatus 10, the packet analysis model learning apparatus 20, the waveform analysis model learning apparatus 30, the analysis model management apparatus 40, and the traffic information collection apparatus 50) of the device estimation system 1 according to the present embodiment are realized by, for example, a computer 900 having the configuration as illustrated in FIG. 9.

FIG. 9 is a hardware configuration diagram illustrating an example of the computer 900 that realizes functions of each apparatus of the device estimation system 1 according to the present embodiment. The computer 900 has a central processing unit (CPU) 901, a read only memory (ROM) 902, a RAM 903, a hard disk drive (HDD) 904, an input/output interface (I/F) 905, a communication I/F 906, and a media I/F 907.

The CPU 901 operates based on a program stored in the ROM 902 or the HDD 904 and performs control with each control unit. The ROM 902 stores a boot program executed by the CPU 901 when the computer 900 is started, a program related to the hardware of the computer 900, and the like.

The CPU 901 controls an input device 910 such as a mouse and a keyboard and an output device 911 such as a display or a printer via the input/output I/F 905. The CPU 901 acquires data from the input device 910 via the input/output I/F 905 and outputs generated data to the output device 911. A graphics processing unit (GPU) or the like may be used together with the CPU 901 as processors.

The HDD 904 stores a program to be executed by the CPU 901, data to be used by the program, etc. The communication I/F 906 receives data from other devices via a communication network (e.g., NW (network) 920), outputs the received data to the CPU 901, and transmits data generated by the CPU 901 to other devices via the communication network.

The media I/F 907 reads the program or data stored in a recording medium 912 and outputs it to the CPU 901 via the RAM 903. The CPU 901 loads a program related to target processing from the recording medium 912 onto the RAM 903 via the media I/F 907, and executes the loaded program. The recording medium 912 is an optical recording medium such as a digital versatile disc (DVD) or a phase change rewritable disk (PD), a magneto-optical recording medium such as a magneto-optical disk (MO), a magnetic recording medium, a semiconductor memory, or the like.

For example, when the computer 900 functions as each apparatus of the present invention (the device estimation apparatus 10, the packet analysis model learning apparatus 20, the waveform analysis model learning apparatus 30, the analysis model management apparatus 40, and the traffic information collection apparatus 50), the CPU 901 of the computer 900 executes a program loaded on the RAM 903 to realize the function of the apparatus. In addition, data in the RAM 903 is stored in the HDD 904. The CPU 901 reads a program related to target processing from a recording medium 912 and executes it. In addition, the CPU 901 may read a program related to target processing from another apparatus via a communication network (NW 920).

### <Effects>

Effects of the device estimation system according to the present invention will be described below.

A device estimation system according to the present invention is a device estimation system 1 having a device on a network (the management target network 1000) as an estimation target, the device estimation system 1 including the traffic information collection apparatus 50 for collecting traffic information of a target device 5 indicating a device to be estimated, the device estimation apparatus 10 connected to the traffic information collection apparatus 50, and the packet analysis model learning apparatus 20, the waveform analysis model learning apparatus 30, and the analysis model management apparatus 40 connected to the device estimation apparatus 10.

The packet analysis model learning apparatus 20 acquires and learns the first learning data set 431 from the analysis model management apparatus 40 to generate the packet analysis model 200 for outputting candidates for the manufacturer and functional category of the target device 5 when a statistical value and a keyword extracted from the header and payload of a packet transmitted by the target device 5 are input.

In addition, the waveform analysis model learning apparatus 30 acquires and learns a second learning data set from the analysis model management apparatus 40 to generate the waveform analysis model 300 for outputting the functional category of the target device when traffic waveform information indicating a temporal change in the number of packets transmitted by the target device 5 is input.

The traffic information collection apparatus 50 includes the data collection unit 51 for collecting packets in traffic on a network and the packet set generation unit 52 for generating packet set information in which the collected packets are made into a set for each transmission source device which is the target device 5.

The device estimation apparatus 10 includes the device connection information extraction unit 11 that receives packet set information and extracts device connection information indicating information for connecting to the target device 5; the packet processing unit 12 that receives the packet set information from the traffic information collection apparatus 50, extracts a statistical value and a keyword from the header and payload of the packet of the target device 5, inputs the statistical value and keyword to the packet analysis model 200 acquired from the packet analysis model learning apparatus 20, and thereby generates the device classification candidate information 210 indicating candidates for the manufacturer and functional category of the target device 5; the traffic waveform processing unit 13 that receives the packet set information from the traffic information collection apparatus 50, generates traffic waveform information of the target device 5, inputs the traffic waveform information to the waveform analysis model 300 acquired from the waveform analysis model learning apparatus 30, then determines the functional category of the target device 5, and estimates that, among candidates for the manufacturer and functional category indicated by the device classification candidate information 210, a candidate having the determined functional category is for the manufacturer and functional category of the target device 5; and the device specifying unit 14 that generates device specification information including the estimated manufacturer and functional category and the extracted device connection information of the target device and transmits the information to the analysis model management apparatus 40.

In this way, the device estimation apparatus 10 of the device estimation system 1 extracts the statistical value and the keyword from the header and payload extracted from the packet of the target device 5, and inputs the statistical value and the keyword to the packet analysis model 200 acquired from the packet analysis model learning apparatus 20 to generate candidates for the manufacturer and functional category of the target device 5. In addition, the device estimation apparatus 10 generates traffic waveform information from the packet of the target device 5, inputs the information to the waveform analysis model 300 acquired from the waveform analysis model learning apparatus 30, thereby determines the functional category of the target device 5, narrows down the candidates, and thereby specifies the manufacturer and functional category of the target device 5.

Thus, with the device estimation system 1, the accuracy at which the manufacturer and functional category of the target device 5 are estimated from traffic on the network can be improved.

In addition, in the device estimation system 1, the packet processing unit 12 of the device estimation apparatus 10 transmits the extracted statistical value and keyword to the packet analysis model learning apparatus 20, the traffic waveform processing unit 13 of the device estimation apparatus 10 transmits the generated traffic waveform information to the waveform analysis model learning apparatus 30, the analysis model management apparatus 40 transmits the acquired device specification information to the packet analysis model learning apparatus 20 and the waveform analysis model learning apparatus 30, the packet analysis model learning apparatus 20 creates a new learning data set by having the received statistical value and keyword and the manufacturer and functional category indicated by the device specification information as a set, re-learns and updates the packet analysis model 200, and transmits the updated packet analysis model 200 to the device estimation apparatus 10, and the waveform analysis model learning apparatus 30 creates a new learning data set by having the received traffic waveform information and the functional category indicated by the device specification information as a set, re-learns and updates the waveform analysis model 300, and transmits the updated waveform analysis model 300 to the device estimation apparatus.

As described above, the packet analysis model learning apparatus 20 acquires the information of the statistical value and the keyword extracted from the packet of the target device by the device estimation apparatus 10 and information of the manufacturer and functional category which are device estimation results to generate a learning data set, and can re-learn the packet analysis model. In addition, the waveform analysis model learning apparatus 30 acquires traffic waveform information generated from the packet of the target device by the device estimation apparatus 10 and information on the functional category as a device estimation result to generate a learning data set, and can re-learn the waveform analysis model.

Thus, the device estimation apparatus 10 can acquire the re-learned packet analysis model and waveform analysis model, thereby further improving the accuracy and estimating the target device 5.

In addition, in the device estimation system 1, the packet analysis model learning apparatus 20 transmits a new learning data set created by itself to the analysis model management apparatus 40, adds the learning data set to the first learning data set 431 to be updated, and the waveform analysis model learning apparatus 30 transmits a new learning data set created by itself to the analysis model management apparatus 40, adds the learning data set to the second learning data set 432 to be updated.

With this configuration, the number of learning data sets stored in the analysis model management apparatus 40 can be increased each time the packet estimation processing is performed. Thus, the packet analysis model 200 and the waveform analysis model 300 with higher accuracy can be generated by each of the packet analysis model learning apparatus 20 and the waveform analysis model learning apparatus 30.

A device estimation apparatus according to the present invention is the device estimation apparatus 10 having a device on a network to be estimated, the device estimation apparatus including the device connection information extraction unit 11 that receives packet set information in which packets collected from the network are grouped into a set for each transmission source device and extracts device connection information indicating information for connecting to a target device 5 indicating a device to be estimated; the packet processing unit 12 that receives the packet set information, extracts a statistical value and a keyword from a header and a payload of a packet of the target device, and inputs the statistical value and the keyword to the packet analysis model 200, then outputs candidates for a manufacturer and a functional category of the target device 5, and thereby generates the device classification candidate information 210 indicating candidates for the manufacturer and functional category of the target device 5; the traffic waveform processing unit 13 that receives the packet set information, generates traffic waveform information indicating a temporal change in the number of packets transmitted by the target device 5, inputs the traffic waveform information to the waveform analysis model 300, then outputs the functional category of the target device 5, and estimates that, among candidates for the manufacturer and functional category indicated by the device classification candidate information 210, a candidate having the output functional category is for the manufacturer and functional category of the target device 5; and the device specifying unit 14 that generates device specification information including the estimated manufacturer and functional category and the extracted device connection information of the target device 5.

According to the device estimation apparatus 10, the accuracy at which the manufacturer and functional category of the target device 5 are estimated from traffic on the network can be improved.

A packet analysis model learning apparatus according to the present invention is the packet analysis model learning apparatus 20 connected to the device estimation apparatus 10 having a device on a network to be estimated and the analysis model management apparatus 40, the packet analysis model learning apparatus 20 including the data collection section 211 that acquires a learning data set indicated by a set of a statistical value and a keyword extracted from a packet of a target device 5 indicating a device to be estimated and a manufacturer and a functional category of the target device 5 from the analysis model management apparatus 40; the learning section 213 that generates, by using the acquired learning data set, the packet analysis model 200 for outputting candidates for the manufacturer and functional category of the target device 5 when the statistical value and keyword extracted from the header and payload of the packet transmitted by the target device 5 are input; and the packet analysis model output section 214 that transmits the generated packet analysis model 200 to the device estimation apparatus 10, in which the data collection section 211 acquires information of the statistical value and keyword extracted from the packet of the target device 5 from the device estimation apparatus 10, acquires information of the manufacturer and functional category specified for the target device 5 from the analysis model management apparatus 40, and creates a new learning data set having the acquired statistical value and keyword and the acquired manufacturer and functional category as a set, the learning section 213 re-learns and updates the packet analysis model 200, and the packet analysis model output section 214 transmits the updated packet analysis model 200 to the device estimation apparatus 10.

According to the packet analysis model learning apparatus 20, a new learning data set is created every time the device estimation apparatus 10 executes the packet estimation processing, and thus the packet analysis model 200 can be updated. Thus, the packet analysis model 200 having higher estimation accuracy can be provided to the device estimation apparatus 10.

A waveform analysis model learning apparatus according to the present invention is the waveform analysis model learning apparatus 30 connected to the device estimation apparatus 10 having a device on a network to be estimated and the analysis model management apparatus 40, the waveform analysis model learning apparatus 30 including the data collection section 311 that acquires a learning data set indicated by a set of traffic waveform information indicating a temporal change in the number of packets transmitted by a target device 5 indicating a device to be estimated and a functional category of the target device 5 from the analysis model management apparatus 40; the learning section 313 that generates, by using the acquired learning data set, the waveform analysis model 300 for outputting the functional category of the target device 5 when the traffic waveform information is input; and the waveform analysis model output section 314 that transmits the generated waveform analysis model 300 to the device estimation apparatus 10, in which the data collection section 311 acquires the traffic waveform information of the target device 5 from the device estimation apparatus 10, acquires information of the functional category specified for the target device 5 from the analysis model management apparatus 40, and creates a new learning data set having the acquired traffic waveform information and the acquired functional category as a set, the learning section 313 re-learns and updates the waveform analysis model 300, and the waveform analysis model output section 314 transmits the updated waveform analysis model 300 to the device estimation apparatus 10.

According to the waveform analysis model learning apparatus 30, a new learning data set is created every time the device estimation apparatus 10 executes the packet estimation processing, and thus the waveform analysis model 300 can be updated. Thus, the waveform analysis model 300 having higher estimation accuracy can be provided to the device estimation apparatus 10.

The present invention is not limited to the embodiment described above, and various modifications can be made by a person with general knowledge in the field belonging to the technical idea of the present invention.

### REFERENCE SIGNS LIST

1 Device estimation system
5 Device (target device)
6 Switch
10 Device estimation apparatus
11 Device connection information extraction unit
12 Packet processing unit
13 Traffic waveform processing unit
14 Device specifying unit
20 Packet analysis model learning apparatus
21, 31, 41 Control unit
22, 32, 42 Input/output unit
23, 33, 43 Storage unit
30 Waveform analysis model learning apparatus
40 Analysis model management apparatus
50 Traffic information collection apparatus
51 Data collection unit
52 Packet set generation unit
53 Packet set DB
121 Packet extraction section
122 Packet information analysis section
131 Traffic waveform generation section
132 Traffic waveform analysis section
200 Packet analysis model
210 Device classification candidate information
211, 311 Data collection section
212, 312 Data set creation section
213, 313 Learning section
214 Packet analysis model output section
230, 330 Learning data set
300 Waveform analysis model
314 Waveform analysis model output section
411 Initial learning data providing section
412 Device specification information processing section
413 Learning data updating section
430 Initial learning data DB
431 First learning data set
432 Second learning data set
500 Packet set information
1000 Management target network

1. A device estimation system having a device on a network to be estimated,
the device estimation system comprising:
a traffic information collection apparatus configured to collect traffic information of a target device indicating the device to be estimated;
a device estimation apparatus connected to the traffic information collection apparatus; and
a packet analysis model learning apparatus, including one or more processors, a waveform analysis model learning apparatus, including one or more processors, and an analysis model management apparatus, including one or more processors, connected to the device estimation apparatus, wherein
the packet analysis model learning apparatus is configured to acquire and learn a first learning data set from the analysis model management apparatus to generate a packet analysis model for outputting a candidate for a manufacturer and a functional category of the target device when a statistical value and a keyword extracted from a header and a payload of a packet transmitted by the target device are input, and
the waveform analysis model learning apparatus is configured to acquire and learn a second learning data set from the analysis model management apparatus to generate a waveform analysis model for outputting the functional category of the target device when traffic waveform information indicating a temporal change in the number of packets transmitted by the target device is input,
the traffic information collection apparatus including
a data collection section, including one or more processors, configured to collect packets in traffic on the network, and
a packet set generation section, including one or more processors, configured to generate packet set information in which the collected packets are grouped into a set for each transmission source device that is the target device, and
the device estimation apparatus including
a device connection information extraction unit, including one or more processors, configured to receive the packet set information and extract device connection information indicating information for connecting to the target device,
a packet processing unit, including one or more processors, configured to receive the packet set information from the traffic information collection apparatus, extract the statistical value and keyword from the header and payload of the packet of the target device, input the statistical value and keyword to the packet analysis model acquired from the packet analysis model learning apparatus, and thereby generate device classification candidate information indicating a candidate for the manufacturer and functional category of the target device,
a traffic waveform processing unit, including one or more processors, configured to receive the packet set information from the traffic information collection apparatus, generate the traffic waveform information of the target device, input the traffic waveform information to the waveform analysis model acquired from the waveform analysis model learning apparatus, then determine the functional category of the target device, and estimate that, among candidates for the manufacturer and functional category indicated by the device classification candidate information, a candidate having the determined functional category is for the manufacturer and functional category of the target device, and
a device specifying unit, including one or more processors, configured to generate device specification information including the estimated manufacturer and functional category and the extracted device connection information of the target device and transmit the device specification information to the analysis model management apparatus.

2. The device estimation system according to claim 1, wherein
the packet processing unit of the device estimation apparatus is configured to transmit the extracted statistical value and keyword to the packet analysis model learning apparatus,
the traffic waveform processing unit of the device estimation apparatus is configured to transmit the generated traffic waveform information to the waveform analysis model learning apparatus,
the analysis model management apparatus is configured to transmit the acquired device specification information to the packet analysis model learning apparatus and the waveform analysis model learning apparatus,
the packet analysis model learning apparatus is configured to create a new learning data set by having the received statistical value and keyword and the manufacturer and functional category indicated by the device specification information as a set, re-learns and updates the packet analysis model, and transmit the updated packet analysis model to the device estimation apparatus, and
the waveform analysis model learning apparatus is configured to create a new learning data set by having the received traffic waveform information and the functional category indicated by the device specification information as a set, re-learns and updates the waveform analysis model, and transmit the updated waveform analysis model to the device estimation apparatus.

3. The device estimation system according to claim 2, wherein
the packet analysis model learning apparatus is configured to transmit the new learning data set created by the packet analysis model learning apparatus to the analysis model management apparatus, and add the new learning data set to the first learning data set to be updated, and
the waveform analysis model learning apparatus is configured to transmit the new learning data set created by the waveform analysis model learning apparatus to the analysis model management apparatus, and add the new learning data set to the second learning data set to be updated.

4. A device estimation apparatus having a device on a network to be estimated, comprising:
a device connection information extraction unit, including one or more processors, configured to receive packet set information in which packets collected from the network are grouped into a set for each transmission source device and extract device connection information indicating information for connecting to a target device indicating the device to be estimated;
a packet processing unit, including one or more processors, configured to receive the packet set information, extract a statistical value and a keyword from a header and a payload of a packet of the target device, and input the statistical value and keyword to a packet analysis model, then output candidates for a manufacturer and a functional category of the target device, and thereby generate device classification candidate information indicating a candidate for the manufacturer and functional category of the target device;
a traffic waveform processing unit, including one or more processors, configured to receive the packet set information, generate traffic waveform information indicating a temporal change in the number of packets transmitted by the target device, input the traffic waveform information to a waveform analysis model, then output the functional category of the target device, and estimate that, among candidates for the manufacturer and functional category indicated by the device classification candidate information, a candidate having the output functional category is for the manufacturer and functional category of the target device; and
a device specifying unit, including one or more processors, configured to generate device specification information including the estimated manufacturer and functional category and the extracted device connection information of the target device.

5. A packet analysis model learning apparatus connected to a device estimation apparatus having a device on a network to be estimated and an analysis model management apparatus,
the packet analysis model learning apparatus comprising:
a data collection section, including one or more processors, configured to acquire a learning data set indicated by a set of a statistical value and a keyword extracted from a packet of a target device indicating the device to be estimated and a manufacturer and a functional category of the target device from the analysis model management apparatus;
a learning section, including one or more processors, configured to generate, by using the acquired learning data set, a packet analysis model for outputting a candidate for the manufacturer and functional category of the target device when the statistical value and keyword extracted from header and payload of the packet transmitted by the target device are input; and
a packet analysis model output section, including one or more processors, configured to transmit the generated packet analysis model to the device estimation apparatus, wherein
the data collection section is configured to acquire information of the statistical value and keyword extracted from the packet of the target device from the device estimation apparatus, acquires information of the manufacturer and functional category specified for the target device from the analysis model management apparatus, and
create a new learning data set having the acquired statistical value and keyword and the acquired manufacturer and functional category as a set, the learning section is configured to re-learn and update the packet analysis model, and the packet analysis model output section is configured to transmit the updated packet analysis model to the device estimation apparatus.

6. (canceled)

7. A non-transitory computer-readable storage medium storing a program for causing a computer to function as the device estimation apparatus according to claim 4.

8. A non-transitory computer-readable storage medium storing a program for causing a computer to function as the packet analysis model learning apparatus according to claim 5.

9. (canceled)
